(19) United States
(12) Patent Application Publication
(10) Pub. No.: US 2010/0241287 A1
(43) Pub. Date: Sep. 23, 2010

(54) AIR CONDITIONING CONTROL DEVICE, AIR CONDITIONING APPARATUS, AND AIR CONDITIONING CONTROL METHOD

(75) Inventors: Atsushi Nishino, Shiga (JP); Satoshi Hashimoto, Shiga (JP)

Correspondence Address: GLOBAL IP COUNSELORS, LLP, 1233 20TH STREET, NW, SUITE 700, WASHINGTON, DC, 20036-2680, US

(73) Assignee: DAIKIN INDUSTRIES, LTD., Osaka-shi, Osaka (JP)

(21) Appl. No.: 12/739,979

(22) PCT Filed: Nov. 4, 2008
(86) PCT No.: PCT/JP2008/003161

§ 371 Date: Apr. 27, 2010

(30) Foreign Application Priority Data
Nov. 5, 2007 (JP) 2007-287856

(51) Int. Cl. G06F 1/32; F25B 13/00; F25B 41/04; F25B 49/02; G05D 23/19

(52) U.S. Cl. 700/300; 62/160; 62/222; 62/228.1

(57) ABSTRACT

An air conditioning control device is used to control an air conditioner having a utilization unit and a heat source unit. The air conditioning control device includes a state detection unit and a mitigation control unit. The state detection unit is configured to detect an increased energy state where a space temperature of an air conditioning target space of the utilization unit is frequently below a set temperature of the utilization unit during cooling operation or frequently exceeds the set temperature of the utilization unit during heating operation. The mitigation control unit is configured to control the air conditioner so as to mitigate the increased energy state when the state detection unit detects the increased energy state.

### TECHNICAL FIELD

The present invention relates to an air conditioning control device, an air conditioning apparatus, and an air conditioning control method.

### BACKGROUND ART

Normally, an air conditioner has a utilization unit and a heat source unit and forms a refrigerant circuit through which refrigerant flows. Usually, the utilization unit is installed inside a room that becomes an air conditioning target space, and the heat source unit is installed outdoors. Further, a utilization heat exchanger is disposed inside a casing of the utilization unit, and a heat source heat exchanger is disposed inside a casing of the heat source unit. During cooling operation, the refrigerant absorbs heat in the utilization heat exchanger and releases heat in the heat source heat exchanger. On the other hand, during heating operation, the refrigerant releases heat in the utilization heat exchanger and absorbs heat in the heat source heat exchanger. Thus, the inside of the room where the utilization unit is placed becomes cooled or heated.

Additionally, usually, in order to keep the room temperature in the vicinity of a set temperature, the utilization unit is configured such that it is switched thermo-ON or thermo-OFF when the room temperature diverges by an amount equal to or greater than a predetermined temperature ΔT from the set temperature. When the utilization unit is thermo-ON, this is a state where the refrigerant is flowing inside the utilization heat exchanger and sufficient heat exchange is being performed between the refrigerant and the room air, and when the utilization unit is OFF, this is a state where the refrigerant is not or is virtually not flowing inside the utilization heat exchanger and heat exchange is not being performed substantially between the refrigerant and the room air.

Patent document 1 points out that this repeated switching thermo-ON and thermo-OFF is not preferable from the standpoint of saving energy.

Patent Document 1: JP-A No. 2007-255832

### DISCLOSURE OF THE INVENTION

### Technical Problem

Incidentally, excessively air-conditioning the room—that is, lowering the room temperature below the set temperature during cooling operation or raising the room temperature above the set temperature during heating operation—is a waste of energy. However, even in a state where the room is being excessively air-conditioned, in a state where the difference between the room temperature and the set temperature is small (in a state where the difference falls within ΔT mentioned above), sometimes that state ends up being stable without the utilization unit being switched thermo-OFF. When ΔT mentioned above is reduced, the indoor unit becomes repeatedly switched thermo-ON and thermo-OFF in short cycles, and as feared also in patent document 1, it is also conceivable for this to bring about energy loss. Further, when the indoor unit is repeatedly switched thermo-ON and thermo-OFF, there is also the fear that the room temperature will rise and fall dramatically and impart a feeling of discomfort to the user.

An object of the present invention is to avoid a situation where an air conditioning target space is excessively air-conditioned and realize energy-saving air conditioning operation.

### Solution to the Problem

An air conditioning control device pertaining to a first aspect of the invention comprises a state detection unit and a mitigation control unit and controls an air conditioner. The air conditioner has a utilization unit and a heat source unit. The state detection unit detects an increased energy state. The increased energy state is a state where a space temperature is frequently below a set temperature of the utilization unit during cooling operation or frequently exceeds the set temperature of the utilization unit during heating operation. The space temperature is a temperature of an air conditioning target space of the utilization unit. The mitigation control unit controls the air conditioner so as to mitigate the increased energy state when the state detection unit detects the increased energy state.

This air conditioning control device mitigates air conditioning operation by the air conditioner when it judges that the air conditioning target space is being excessively air-conditioned. The state where the air conditioning target space is being excessively air-conditioned is a state where the air conditioning target space is cooled below the set temperature and is substantially stable during cooling operation or a state where the air conditioning target space is heated above the set temperature and is substantially stable during heating operation. Thus, energy-saving air conditioning operation can be realized.

An air conditioning control device pertaining to a second aspect of the invention is the air conditioning control device pertaining to the first aspect of the invention, wherein the mitigation control unit controls the air conditioner such that an amount of refrigerant flowing through the utilization unit decreases when the state detection unit detects the increased energy state.

This air conditioning control device decreases the amount of refrigerant flowing through the utilization unit when it judges that the air conditioning target space is being excessively air-conditioned. Thus, air conditioning operation by the air conditioner can be mitigated.

An air conditioning control device pertaining to a third aspect of the invention is the air conditioning control device pertaining to the first or second aspect of the invention, wherein the state detection unit detects a difference value that is the space temperature minus the set temperature a predetermined number of times and detects the increased energy state when an integrated value of the difference values is smaller than a first value during cooling operation or when the integrated value of the difference values is larger than a second value during heating operation. The first value and the second value may be the same value or may be different values.

This air conditioning control device detects the difference value that is the space temperature minus the set temperature the predetermined number of times. Additionally, the air conditioning control device judges that the air conditioning target space is being excessively air-conditioned when the integrated value of the detected difference values is too small during cooling operation or when the integrated value of the detected difference values is too large during heating operation.

That is, during cooling operation, it is judged that the air conditioning target space is being excessively air-conditioned when “Σ(space temperature−set temperature)<the first value”, and during heating operation, it is judged that the air conditioning target space is being excessively air-conditioned when “Σ(space temperature−set temperature)>the second value”. Σ means integration corresponding to the number of times of detection of the difference values.

Thus, how much the space temperature is diverging from the set temperature toward the increased energy side can be judged.

An air conditioning control device pertaining to a fourth aspect of the invention is the air conditioning control device pertaining to the first or second aspect of the invention, wherein the state detection unit determines a magnitude relation between the space temperature and the set temperature a first number of times and detects the increased energy state when the space temperature is smaller a number of times equal to or greater than a second number of times during cooling operation or when the space temperature is larger a number of times equal to or greater than a third number of times during heating operation. The first number of times, the second number of times and the third number of times may be the same value or may be different values.

This air conditioning control device determines the magnitude relation between the space temperature and the set temperature the first number of times. Additionally, the air conditioning control device judges that the air conditioning target space is being excessively air-conditioned when the space temperature is lower a number of times equal to or greater than the second number of times during cooling operation or when the space temperature is higher a number of times equal to or greater than the third number of times during heating operation.

That is, during cooling operation, whether or not “space temperature<set temperature” is true is determined the first number of times, and when “space temperature<set temperature” is true a number of times equal to or greater than the second number of times, it is judged that the air conditioning target space is being excessively air-conditioned, and during heating operation, whether or not “space temperature>set temperature” is true is determined the first number of times, and when “space temperature>set temperature” is true a number of times equal to or greater than the third number of times, it is judged that the air conditioning target space is being excessively air-conditioned.

Thus, how much the space temperature is diverging from the set temperature toward the increased energy side can be judged.

An air conditioning control device pertaining to a fifth aspect of the invention is the air conditioning control device pertaining to the first or second aspect of the invention, wherein the state detection unit detects the increased energy state when the space temperature continues to be below the set temperature an amount of time longer than a first amount of time during cooling operation or when the space temperature continues to exceed the set temperature an amount of time longer than a second amount of time during heating operation. The first amount of time and the second amount of time may be the same value or may be different values.

This air conditioning control device judges that the air conditioning target space is being excessively air-conditioned when the space temperature continues to be lower than the set temperature for a long time during cooling operation or when the space temperature continues to be higher than the set temperature for a long time during heating operation.

That is, during cooling operation, it is judged that the air conditioning target space is being excessively air-conditioned when “space temperature<set temperature” continues to be true for an amount of time longer than the first amount of time, and during heating operation, it is judged that the air conditioning target space is being excessively air-conditioned when “space temperature>set temperature” continues to be true for an amount of time longer than the second amount of time.

Thus, how much the space temperature is diverging from the set temperature toward the increased energy side can be judged.

An air conditioning control device pertaining to a sixth aspect of the invention is the air conditioning control device pertaining to any of the first to fifth aspects of the invention, wherein the mitigation control unit executes at least one control selected from the group consisting of expansion mechanism control, degree-of-superheating control, degree-of-supercooling control, compressor control, evaporation temperature control, condensation temperature control, cooling set temperature control and heating set temperature control. The expansion mechanism control is control that reduces the degree of opening of an expansion mechanism included in the utilization unit. The degree-of-superheating control is control that raises the degree of superheating. The degree-of-supercooling control is control that raises the degree of supercooling. The compressor control is control that lowers the frequency of a compressor. The evaporation temperature control is control that raises the evaporation temperature of the refrigerant. The condensation temperature control is control that lowers the condensation temperature of the refrigerant. The cooling set temperature control is control that raises the set temperature during cooling operation. The heating set temperature control is control that lowers the set temperature during heating operation.

This air conditioning control device performs at least one control among the following eight when it judges that the air conditioning target space is being excessively air-conditioned: (1) reduce the degree of opening of the expansion mechanism; (2) raise the degree of superheating; (3) raise the degree of supercooling; (4) lower the frequency of the compressor; (5) raise the evaporation temperature; (6) lower the condensation temperature; (7) raise the set temperature during cooling operation; and (8) lower the set temperature during heating operation.

Thus, air conditioning operation by the air conditioner can be mitigated.

An air conditioning control device pertaining to a seventh aspect of the invention is the air conditioning control device pertaining to any of the first to sixth aspects of the invention and further comprises a mitigation prohibition unit. The mitigation prohibition unit prohibits control by the mitigation control unit under at least one situation selected from the group consisting of a situation where outdoor humidity is higher than a predetermined humidity value, a situation that is rainy weather, and a situation that is within a predetermined period after startup of the air conditioner.

This air conditioning control device does not mitigate air conditioning operation under the following situation even when it is judged that the air conditioning target space is being excessively air-conditioned: (1) the outside humidity is high; (2) it is rainy weather; and (3) a set amount of time has not elapsed after startup of the air conditioner.

Because of (1) and (2) described above, humidity can be kept comfortable even while cutting wasteful energy consumption, and because of (3) described above, it can be ensured that the effect of air conditioning operation is not delayed.

An air conditioning apparatus pertaining to an eighth aspect of the invention comprises a heat source unit, a utilization unit and a control unit. The utilization unit is connected via a refrigerant pipe to the heat source unit. The control unit controls the operation of the heat source unit and the utilization unit. The control unit has a state detection unit and a mitigation control unit. The state detection unit detects an increased energy state. The increased energy state is a state where a space temperature is frequently below a set temperature of the utilization unit during cooling operation or frequently exceeds the set temperature of the utilization unit during heating operation. The space temperature is a temperature of air conditioning target space of the utilization unit. The mitigation control unit controls the heat source unit and the utilization unit so as to mitigate the increased energy state when the state detection unit detects the increased energy state.

This air conditioning apparatus mitigates air conditioning operation by itself when it judges that the air conditioning target space is being excessively air-conditioned. A state where the air conditioning target space is being excessively air-conditioned is a state where the air conditioning target space is cooled below the set temperature and is substantially stable during cooling operation or a state where the air conditioning target space is heated above the set temperature and is substantially stable during heating operation. Thus, energy-saving air conditioning operation can be realized.

An air conditioning control method pertaining to a ninth aspect of the invention is a method of controlling an air conditioner having a utilization unit and a heat source unit and comprises a state detection step and a mitigation control step. In the state detection step, an increased energy state is detected. The increased energy state is a state where a space temperature is frequently below a set temperature of the utilization unit during cooling operation or frequently exceeds the set temperature of the utilization unit during heating operation. The space temperature is a temperature of air conditioning target space of the utilization unit. In the mitigation control step, the air conditioner is controlled so as to mitigate the increased energy state when the increased energy state is detected in the state detection step.

In this air conditioning control method, it is judged whether or not the air conditioning target space is being excessively air-conditioned, and air conditioning operation is mitigated when it is judged that the air conditioning target space is being excessively air-conditioned. A state where the air conditioning target space is being excessively air-conditioned is a state where the air conditioning target space is cooled below the set temperature and is substantially stable during cooling operation or a state where the air conditioning target space is heated above the set temperature and is substantially stable during heating operation. Thus, energy-saving air conditioning operation can be realized.

### ADVANTAGEOUS EFFECTS OF THE INVENTION

According to the first aspect of the invention, energy-saving air conditioning operation can be realized.

According to the second aspect of the invention, air conditioning operation by the air conditioner can be mitigated.

According to the third aspect of the invention, how much the space temperature is diverging from the set temperature toward the increased energy side can be judged.

According to the fourth aspect of the invention, how much the space temperature is diverging from the set temperature toward the increased energy side can be judged.

According to the fifth aspect of the invention, how much the space temperature is diverging from the set temperature toward the increased energy side can be judged.

According to the sixth aspect of the invention, air conditioning operation by the air conditioner can be mitigated.

According to the seventh aspect of the invention, humidity can be kept comfortable and it can be ensured that the effect of air conditioning operation is not delayed even while cutting wasteful energy consumption.

According to the eighth aspect of the invention, energy-saving air conditioning operation can be realized.

According to the ninth aspect of the invention, energy-saving air conditioning operation can be realized.

### BRIEF DESCRIPTION OF THE DRAWINGS

FIG. 1 is a diagram showing an indoor space in which indoor units of an air conditioner are installed.

FIG. 2 is a refrigerant circuit diagram of the air conditioner.

FIG. 3 is a block configuration diagram of the air conditioner and a controller.

FIG. 4 is a diagram describing thermo-ON/OFF switching control in the indoor units during cooling operation.

FIG. 5 is a diagram describing thermo-ON/OFF switching control in the indoor units during heating operation.

FIG. 6 is a diagram showing temperature changes in an increased energy state during cooling operation.

FIG. 7 is a diagram showing temperature changes in the increased energy state during heating operation.

FIG. 8 is a flowchart showing a flow of mitigation level setting processing.

FIG. 9 is a flowchart showing a flow of mitigation level reset processing.

FIG. 10 is a flowchart showing a flow of mitigation level setting processing pertaining to modification (2).

FIG. 11 is a flowchart showing a flow of mitigation level setting processing pertaining to modification (3).

### EXPLANATION OF THE REFERENCE SIGNS

1 Controller
2 Air Conditioner
8 Control Unit
10 Control Unit
11 State Detection Unit
12 Mitigation Control Unit
13 Mitigation Prohibition Unit
30a, 30b, . . . , 30y Indoor Units (Utilization Units)
31 Indoor Heat Exchanger
32 Expansion Valve (Expansion Mechanism)
40 Outdoor Unit (Heat Source Unit)
41 Compressor
Sa, Sb, . . . , Sy Cell Spaces (Air Conditioning Target Spaces)
Tr Room Temperature
Ts Set Temperature
Wr Outdoor Humidity

### BEST MODE FOR CARRYING OUT THE INVENTION

A controller 1 (air conditioning control device) of an air conditioner 2 pertaining to an embodiment of the present invention will be described below with reference to the drawings.

### <Installation Environment of Air Conditioner>

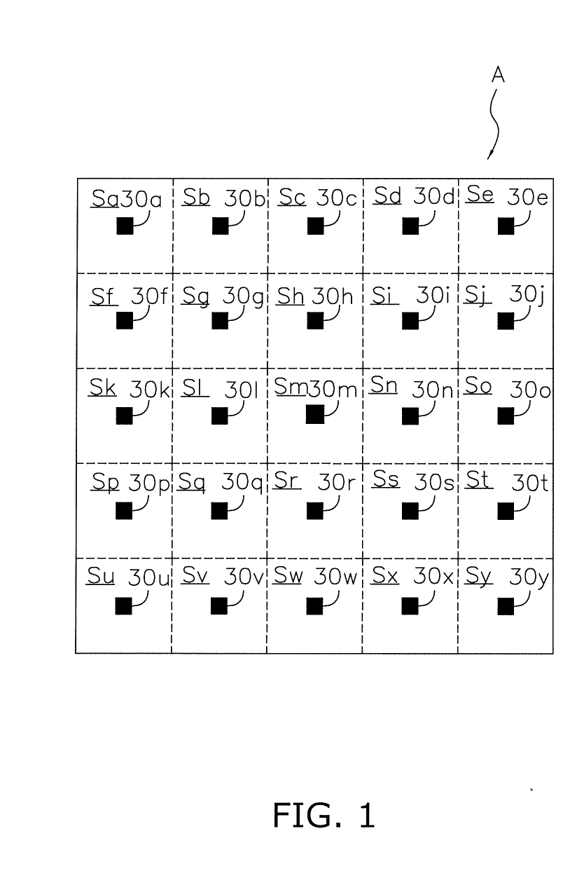

FIG. 1 shows an indoor space A in which indoor units (utilization units) 30a, 30b, . . . , 30y of the air conditioner 2 are installed.

The indoor space A is one space that is open and wide, such as an office floor or a restaurant. In a ceiling of the indoor space A, the plural indoor units 30a, 30b, . . . , 30y are embedded appropriate intervals apart from each other. In FIG. 1, cell spaces Sa, Sb, . . . , Sy delimited by the dotted lines are hypothetically divided spaces that become targets of air conditioning operation by the indoor units 30a, 30b, . . . , 30y respectively installed inside cell spaces Sa, Sb, . . . , Sy.

### <Configuration of Air Conditioner>

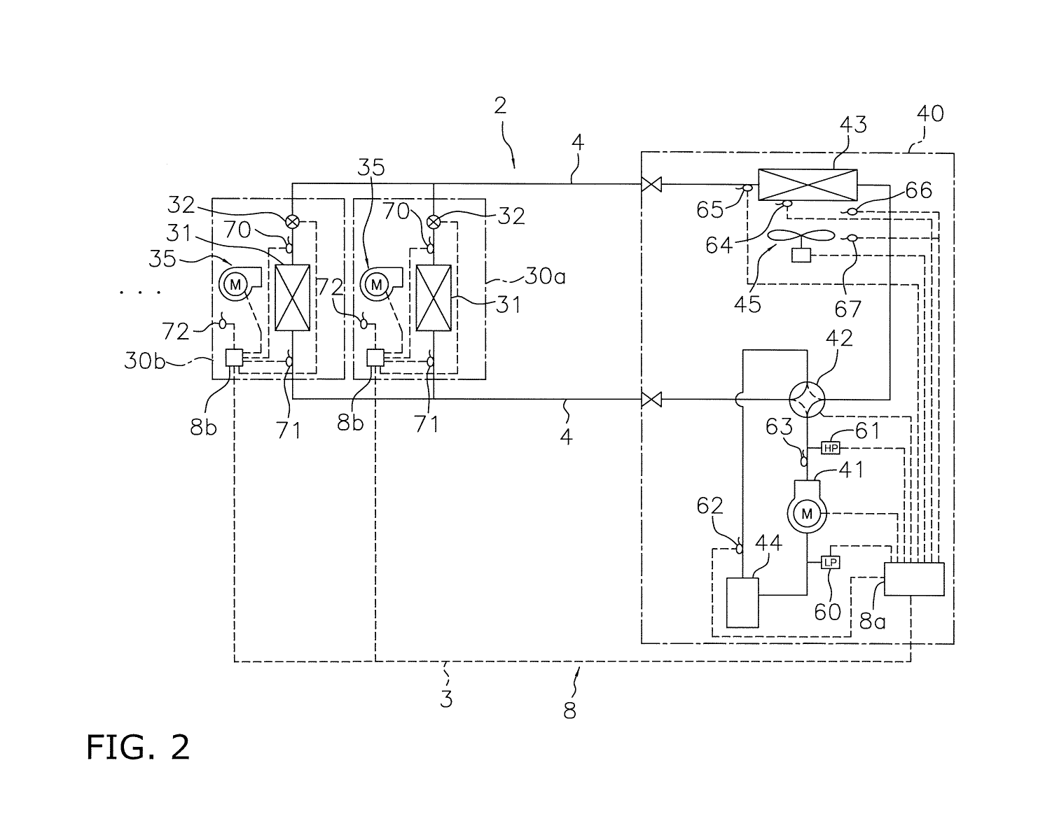

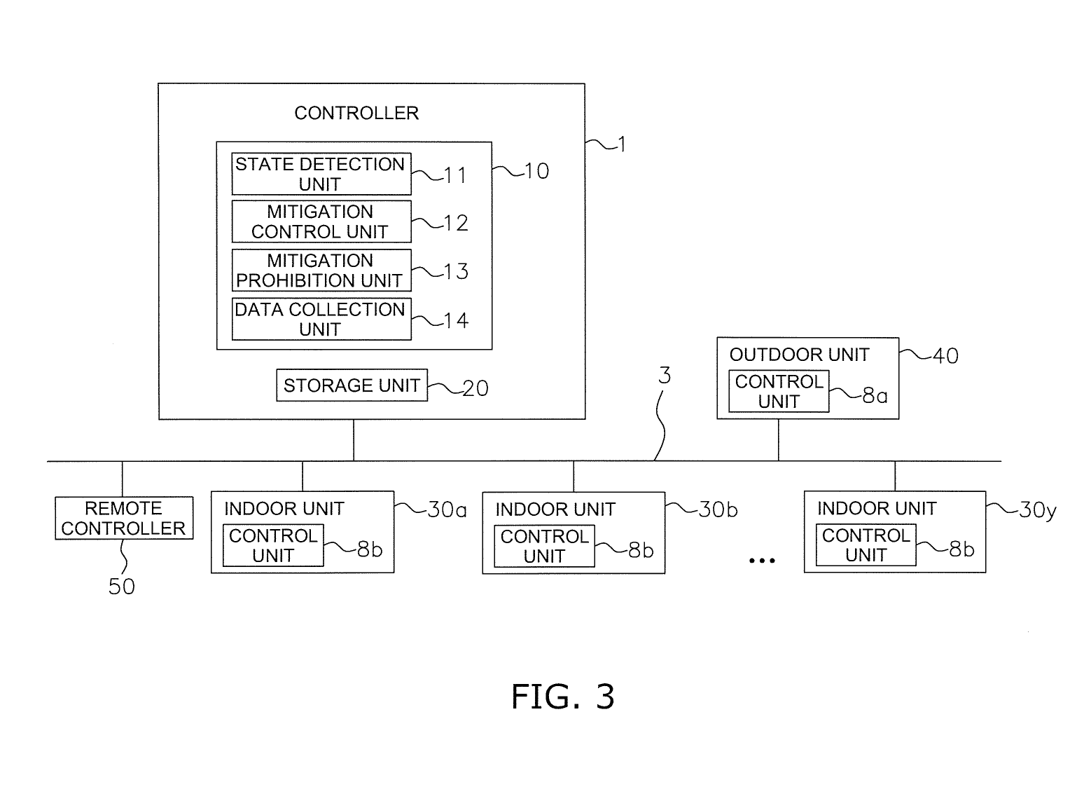

As shown in FIG. 2 and FIG. 3, the air conditioner 2 is a so-called multi-type air conditioner and has an outdoor unit (heat source unit) 40, the plural indoor units 30a, 30b, . . . , 30y and a remote controller 50 that receives input of operation commands with respect to the indoor units 30a, 30b, . . . , 30y. The indoor units 30a, 30b, . . . , 30y are connected in parallel via a refrigerant communication pipe 4 to the outdoor unit 40. The outdoor unit 40 is installed outside, and the remote controller 50 is attached to a wall surface of the indoor space A. The outdoor unit 40, the indoor units 30a, 30b, . . . , 30y and the remote controller 50 are interconnected via a communication line 3. The remote controller 50 receives from a user and transmits to a control unit 8 operation commands relating to starting/stopping each of the indoor units 30a, 30b, . . . , 30y, operation modes (cooling operation mode, heating operation mode, fan mode, etc.), set temperature Ts, air volume, air direction, etc.

Inside a casing of each of the indoor units 30a, 30b, . . . , 30y, there are housed an indoor heat exchanger 31, an expansion valve 32 and an indoor fan 35. Inside a casing of the outdoor unit 40, there are housed a compressor 41, a four-way valve 42, an outdoor heat exchanger 43, an accumulator 44 and an outdoor fan 45. Additionally, the compressor 41, the four-way valve 42, the outdoor heat exchanger 43, the expansion valves 32, the indoor heat exchangers 31 and the accumulator 44 are interconnected via a refrigerant pipe, whereby a refrigerant circuit is formed.

The circulation of refrigerant inside the refrigerant circuit of the air conditioner 2 will be described below.

During cooling operation, the four-way valve 42 is held in the state indicated by the solid lines in FIG. 2. When power is applied to the air conditioner 2, the compressor 41 sucks in gas refrigerant in a low-pressure state and compresses that refrigerant into a high-pressure state. The gas refrigerant in the high-pressure state that has been discharged from the compressor 41 travels through the four-way valve 42, flows into the outdoor heat exchanger 43, exchanges heat with the outdoor air, and condenses. At this time, inside the casing of the outdoor unit 40, an air flow is formed by the driving of the outdoor fan 45 and heat exchange in the outdoor heat exchanger 43 is promoted. The refrigerant that has liquefied in the outdoor heat exchanger 43 travels through the refrigerant communication pipe 4, is guided to the indoor heat exchangers 31 of the indoor units 30a, 30b, . . . , 30y in a thermo-ON state, exchanges heat with the room air in the cell spaces Sa, Sb, . . . , Sy, and evaporates. At this time, inside the casings of the indoor units 30a, 30b, . . . , 30y, air flows are formed by the driving of the indoor fans 35 and heat exchange in the indoor heat exchangers 31 is promoted. The amount of refrigerant that flows into each of the indoor heat exchangers 31 is decided by the degree of opening of the expansion valve 32 on the upstream sides thereof. Then, the air that has been cooled by the evaporation of the refrigerant is blown out into the cell spaces Sa, Sb, . . . , Sy by the indoor fans 35 and cools the cell spaces Sa, Sb, . . . , Sy. Further, the refrigerant that has gasified in the indoor heat exchangers 31 travels through the refrigerant communication pipe 4 and the four-way valve 42 and returns to the compressor 41 of the outdoor unit 40.

On the other hand, during heating operation, the four-way valve 42 is held in the state indicated by the dotted lines in FIG. 2. When power is applied to the air conditioner 2, the compressor 41 sucks in gas refrigerant in a low-pressure state and compresses that refrigerant into a high-pressure state. The gas refrigerant in the high-pressure state that has been discharged from the compressor 41 travels through the four-way valve 42 and the refrigerant communication pipe 4, flows into the indoor heat exchangers 31 of the indoor units 30a, 30b, . . . , 30y in a thermo-ON state, exchanges heat with the room air in the cell spaces Sa, Sb, . . . , Sy, and condenses. At this time, inside the casings of the indoor units 30a, 30b, . . . , 30y, air flows are formed by the driving of the indoor fans 35 and heat exchange in the indoor heat exchangers 31 is promoted. The amount of refrigerant that flows into each of the indoor heat exchangers 31 is decided by the degree of opening of the expansion valve 32 on the downstream side thereof. Then, the air that has been heated by the condensation of the refrigerant is blown out into the cell spaces Sa, Sb, . . . , Sy by the indoor fans 35 and heats the cell spaces Sa, Sb, . . . , Sy. Further, the refrigerant that has liquefied in the indoor heat exchangers 31 travels through the refrigerant communication pipe 4, is guided to the outdoor heat exchanger 43 of the outdoor unit 40, exchanges heat with the outdoor air, and evaporates. At this time, inside the casing of the outdoor unit 40, an air flow is formed by the driving of the outdoor fan 45 and heat exchange in the outdoor heat exchanger 43 is promoted. Further, the refrigerant that has gasified in the outdoor heat exchanger 43 travels through the four-way valve 42 and returns to the compressor 41.

The accumulator 44 placed on the upstream side of the compressor 41 is a container that is capable of accumulating surplus refrigerant generated inside the refrigerant circuit depending on the operating loads of the indoor units 30a, 30b, . . . , 30y.

Inside the casing of the outdoor unit 40, various sensors 60 to 67 are attached. The sensor 60 detects the pressure of the refrigerant in a suction pipe of the compressor 41. The sensor 61 detects the pressure of the refrigerant in a discharge pipe of the compressor 41. The sensor 62 detects the temperature of the refrigerant sucked into the compressor 41. The sensor 63 detects the temperature of the refrigerant discharged from the compressor 41. The sensor 64 detects the temperature of the refrigerant flowing inside the outdoor heat exchanger 43 (the condensation temperature during cooling operation or the evaporation temperature during heating operation). The sensor 65 is attached on a liquid side of the outdoor heat exchanger 43 and detects the temperature of the refrigerant in the liquid state or gas-liquid two-phase state. The sensor 66 detects outdoor temperature. The sensor 67 detects outdoor humidity Wr.

Further, inside the casing of each of the indoor units 30a, 30b . . . 30y also, various sensors 70 to 72 are attached. The sensors 70 are attached on liquid sides of the indoor heat exchangers 31 and detect the temperature of the refrigerant in the liquid state or gas-liquid two-phase state (the condensation temperature during heating operation or the evaporation temperature during cooling operation). The sensors 71 are attached on gas sides of the indoor heat exchangers 31 and detect the temperature of the refrigerant in the gas state or gas-liquid two-phase state. The sensors 72 are attached in the vicinities of room air suction openings formed in the casings of the indoor units 30a, 30b . . . 30y and detect room temperature Tr.

The detection values in the various sensors 60 to 67 and 70 to 72 are transmitted to the control unit 8 at a predetermined time interval K1 (in the present embodiment, every 5 minutes).

The control unit 8 of the air conditioner 2 is mainly configured from an outdoor control unit 8a that is housed inside the casing of the outdoor unit 40 and indoor control units 8b that are housed inside the casings of the indoor units 30a, 30b, . . . , 30y. The control units 8a and 8b each have microcomputers and memories. The outdoor control unit 8a and the indoor control units 8b exchange necessary control signals via the communication line 3 and control air conditioning operation by the air conditioner 2 depending on operation commands from the user that have been inputted via the remote controller 50. For example, the control unit 8 decides control parameters of appropriate parts-to-be-controlled 32, 35, 41, 42, 44 and 45 for realizing air conditioning operation following the operation commands from the user and transmits those control parameters to the corresponding parts-to-be-controlled 32, 35, 41, 42, 44 and 45. The detection values in the various sensors 60 to 67 and 70 to 72 are utilized for the deciding of the control parameters by the control unit 8.

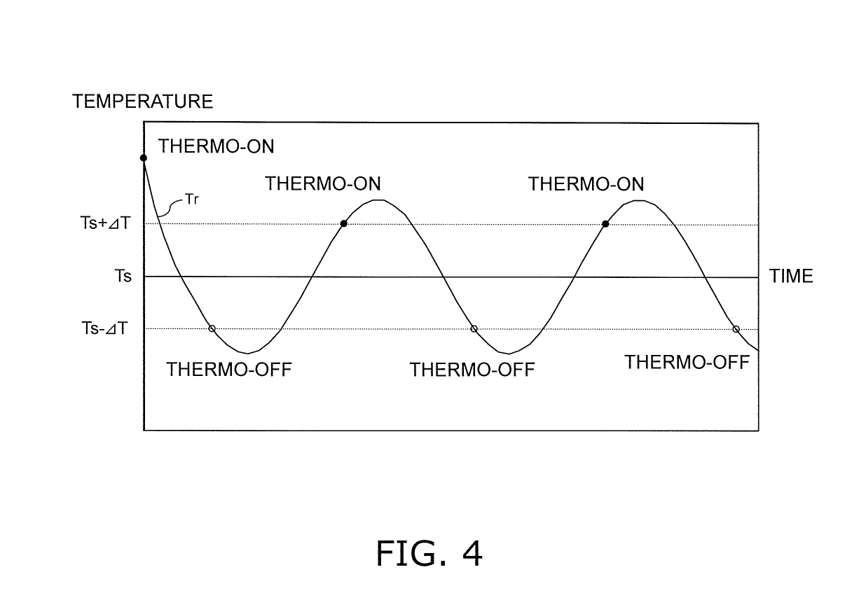

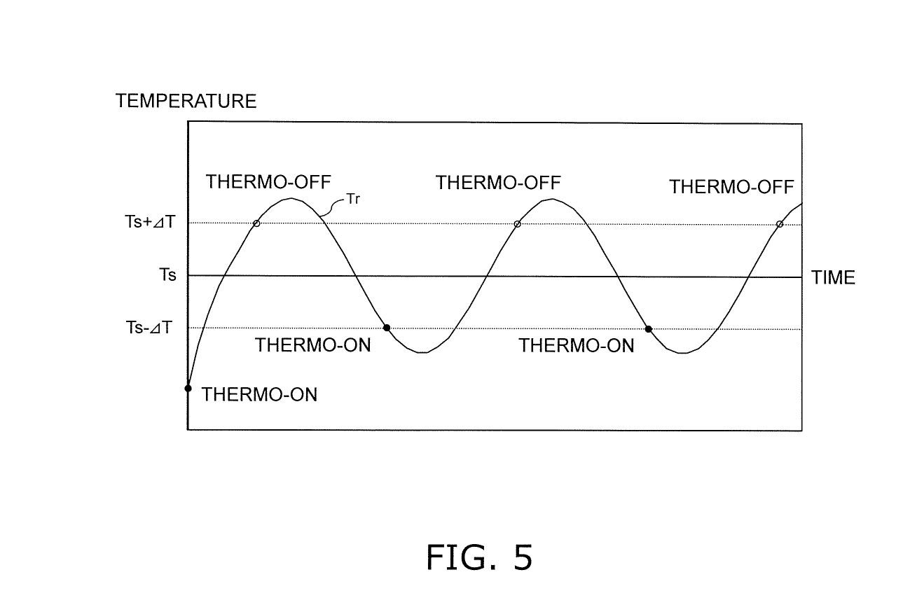

Further, the control unit 8 performs thermo-ON/OFF switching control during cooling operation and during heating operation. The thermo-ON/OFF switching control is control that switches between a thermo-ON state and a thermo-OFF state of the indoor units 30a, 30b, . . . , 30y when, as shown in FIG. 4 and FIG. 5, the room temperature Tr diverges a predetermined temperature ΔT (in the present embodiment, 1° C.) from the set temperature Ts. The thermo-ON state is a state where the refrigerant is flowing inside the indoor heat exchangers 31, and the thermo-OFF state is a state where the expansion valves 32 are closed to the maximum such that the refrigerant is not flowing at all or is virtually not flowing inside the indoor heat exchangers 31. Because of this switching control, the room temperature Tr does not end up greatly diverging from the set temperature Ts.

### <Configuration of Controller>

As shown in FIG. 3, the controller 1 is connected to the control unit 8 (the outdoor control unit 8a and the indoor control units 8b) of the air conditioner 2 via the communication line 3 and monitors and controls air conditioning operation by the air conditioner 2 via the control unit 8. The controller 1 has a control unit 10 and a storage unit 20.

The control unit 10 operates as a state detection unit 11, a mitigation control unit 12, a mitigation prohibition unit 13 and a data collection unit 14 by reading and executing a predetermined program stored in the storage unit 20.

The data collection unit 14 collects the detection values in the sensors 60 to 67 and 70 to 72 from the control unit 8 of the air conditioner 2 at the predetermined time interval K1 (in the present embodiment, every 5 minutes), correlates the collected detection values with the collection times, and stores the collected detection values and the collection times inside the storage unit 20. Further, the data collection unit 14 collects, in real time from the control unit 8 of the air conditioner 2 at the time of input by the user, data of operation commands relating to starting/stopping each of the indoor units 30a, 30b, . . . , 30y, the operation modes, the set temperature Ts, the air volume, the air direction, etc., correlates the collected data with the collection times, and stores the collected data and the collection times inside the storage unit 20. In the storage unit 20, there is ensured a storage capacity sufficient for storing a predetermined amount of time's worth (in the present embodiment, 1 hour's worth) of the above-described data.

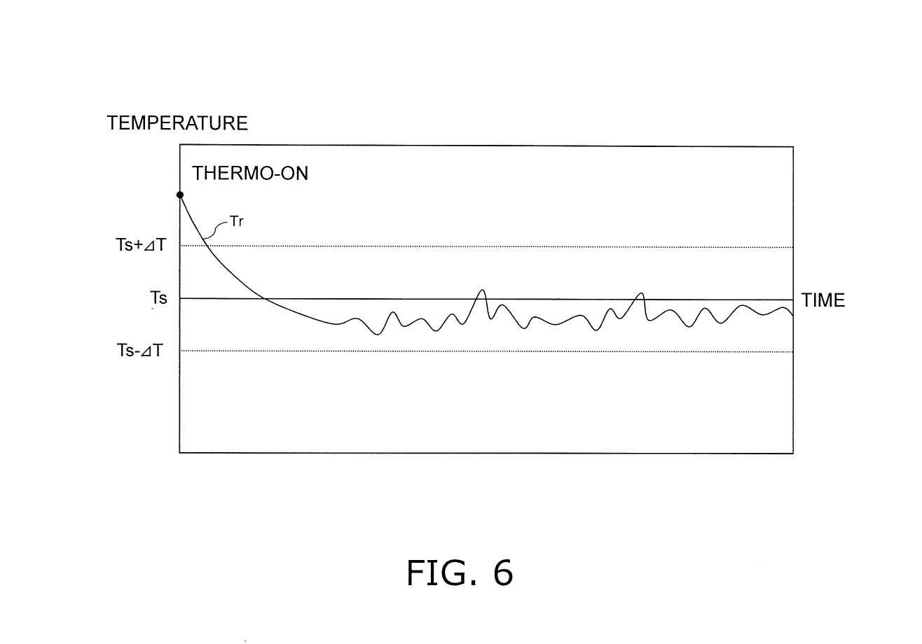

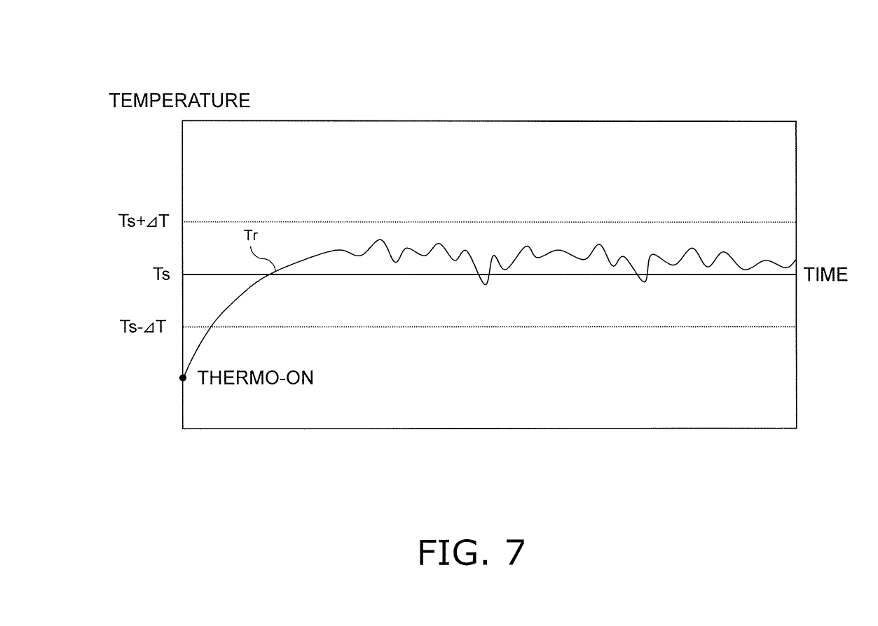

The state detection unit 11 judges, at a predetermined time interval (in the present embodiment, every 1 hour), whether or not each of the cell spaces Sa, Sb, . . . , Sy is in a state where it is being excessively air-conditioned (an increased energy state). As the increased energy state, there is supposed a state where the room temperature Tr changes as shown in FIG. 6 and FIG. 7. That is, if it is during cooling operation (see FIG. 6), the increased energy state is a state where, even though the room temperature Tr is frequently below the set temperature Ts, the indoor unit is not switched thermo-OFF because the room temperature Tr is not diverging by an amount equal to or greater than ΔT from the set temperature Ts. On the other hand, if it is during heating operation (see FIG. 7), the increased energy state is a state where, even though the room temperature Tr frequently exceeds the set temperature Ts, the indoor unit is not switched thermo-OFF because the room temperature Tr is not diverging by an amount equal to or greater than ΔT from the set temperature Ts.

When it has been judged by the state detection unit 11 that certain cell spaces Sa, Sb, . . . , Sy are in the increased energy state, the mitigation control unit 12 commands the control unit 8 of the air conditioner 2 to mitigate air conditioning operation of the indoor units 30a, 30b, . . . , 30y corresponding to those cell spaces Sa, Sb, . . . , Sy in order to mitigate that increased energy state. More specifically, the mitigation control unit 12 performs setting that raises mitigation levels of those indoor units 30a, 30b, . . . , 30y. The mitigation levels are control parameters that the control unit 8 references during control of air conditioning operation.

Six levels—Lv0 to Lv5—are disposed for the mitigation levels, and air conditioning operation becomes mitigated more the higher the mitigation levels of the indoor units 30a, 30b, . . . , 30y are set. More specifically, the indoor units 30a, 30b, . . . , 30y whose mitigation levels are set to Lv0 perform normal air conditioning operation, but as the mitigation levels become higher to Lv1, Lv2, . . . , the expansion valves 32 of the indoor units 30a, 30b, . . . , 30y are narrowed more such that the heat exchange amount in the indoor heat exchangers 31 decreases. Here, assuming that H0 to H5 represent degrees of opening of the expansion valves 32 in Lv0 to Lv5, the degrees of opening H1 to H5 are decided by the expressions below.

H1=H0−Δh1

H2=H0−Δh2

H3=H0−Δh3

H4=H0−Δh4

H5=H0−Δh5

Here, Δh1<Δh2<Δh3<Δh4<Δh5. Consequently, H0>H1>H2>H3>H4>H5, and in the case of the degree of opening H5, the expansion valves 32 reach a state where they are narrowed the most. The control constants Δh1 to Δh5 are stored beforehand in the storage unit 20. Further, other control constants described later are also stored in the storage unit 20.

The mitigation prohibition unit 13 resets, at a predetermined time interval (in the present embodiment, every 5 minutes), as needed the mitigation levels (returns the mitigation levels to Lv0) of each of the indoor units 30a, 30b, . . . , 30y set by the mitigation control unit 12.

The control unit 10 also performs control other than setting of the above-described mitigation levels on the basis of the various types of data that has collected by the data collection unit 14.

### <Flow of Mitigation Level Setting Processing>

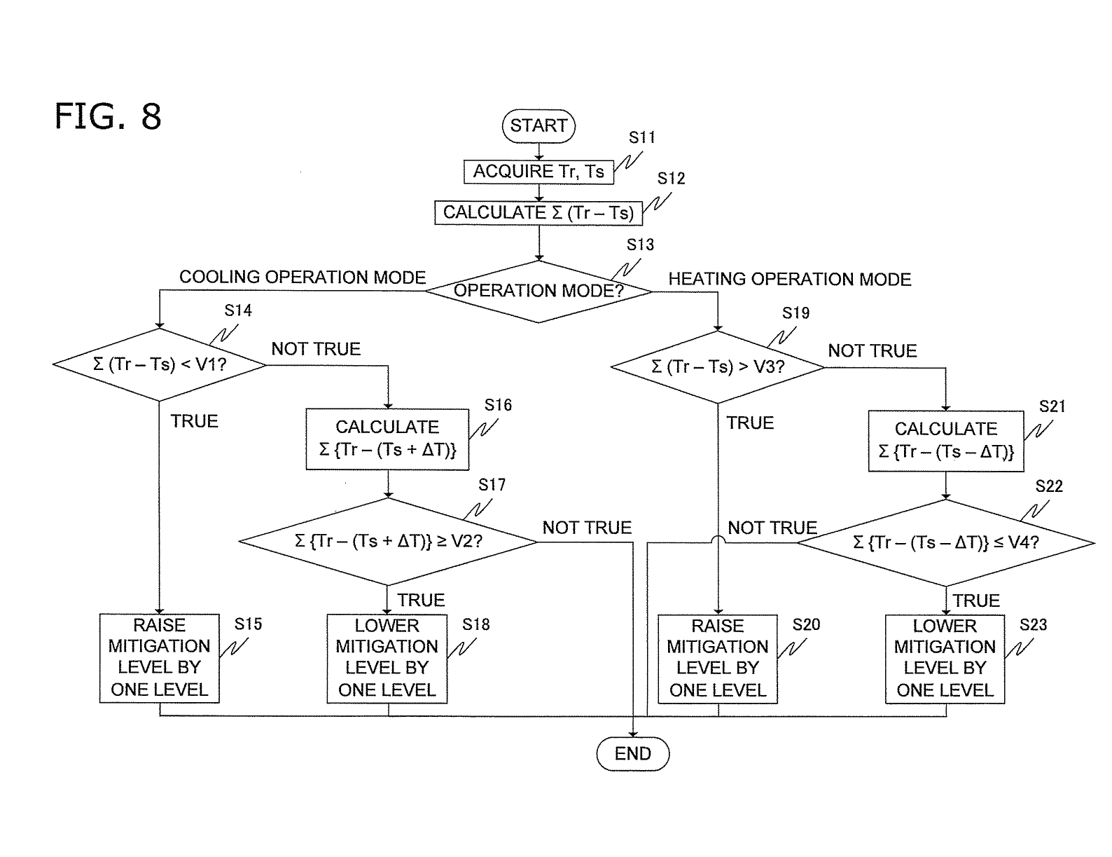

A flow of mitigation level setting processing will be described with reference to FIG. 8. This processing is executed in regard to each of the indoor units 30a, 30b, . . . , 30y at a predetermined time interval (in the present embodiment, every 1 hour). In the description below, a case where the processing is executed in regard to the indoor unit 30a will be exemplified.

In step S11, the state detection unit 11 reads from the storage unit 20 a past amount of time K2's worth (in the present embodiment, 1 hour's worth) of room temperature Tr and set temperature Ts data.

In the next step S12, the state detection unit 11 calculates, for the past amount of time K2, a difference value that is the room temperature Tr minus the set temperature Ts at the times of detection of that room temperature Tr on the basis of the past amount of time K2's worth of room temperature Tr and set temperature Ts data acquired in step S11 and integrates the calculated difference values.

That is, the state detection unit 11 calculates Σ(Tr−Ts). Σ means integration corresponding to the number of times of detection K2/K1 (in the present embodiment, 1 hour/5 minutes=12 times) of the room temperature Tr in the past amount of time K2.

In the next step S13, the state detection unit 11 checks the current operation mode of the indoor unit 30a, proceeds to step S14 if the current operation mode is the cooling operation mode, and proceeds to step 19 if the current operation mode is the heating operation mode.

In step S14, the state detection unit 11 compares the value of Σ(Tr−Ts) calculated in step S12 with a predetermined value V1 (in the present embodiment, 0° C.).

That is, the state detection unit 11 judges whether or not Σ(Tr−Ts)<V1 is true, proceeds to step S15 when Σ(Tr−Ts)<V1 is true, and proceeds to step S16 when Σ(Tr−Ts)<V1 is not true. When Σ(Tr−Ts)<V1 is true, this means that during the past amount of time K2, the room temperature Tr inside the cell space Sa was disproportionately below the set temperature Ts. That is, in step S14, it is judged whether or not the cell space Sa is in the increased energy state.

In step S15, the mitigation control unit 12 commands the control unit 8 of the air conditioner 2 to raise the mitigation level of the indoor unit 30a by one level. When the mitigation level is already at the maximum level Lv5, the control unit 8 of the air conditioner 2 does nothing. When step S15 ends, the mitigation level setting processing also ends.

In step S16, the state detection unit 11 calculates, for the past amount of time K2, a difference value that is the room temperature Tr minus the sum of the set temperature Ts at the times of detection of that room temperature Tr and ΔT (see FIGS. 4 and 5) on the basis of the past amount of time K2's worth of room temperature Tr and set temperature Ts data acquired in step S11 and integrates the calculated difference values.

That is, the state detection unit 11 calculates Σ{Tr−(Ts+ΔT)}. Σ means integration corresponding to the number of times of detection K2/K1 (in the present embodiment, 1 hour/5 minutes=12 times) of the room temperature Tr in the past amount of time K2.

In the next step S17, the state detection unit 11 compares the value of Σ{Tr−(Ts+ΔT)} calculated in step S16 with a predetermined value V2 (in the present embodiment, 0° C.).

That is, the state detection unit 11 judges whether or not Σ{Tr−(Ts+ΔT)}≧V2 is true, proceeds to step S18 when Σ{Tr−(Ts+ΔT)}≧V2 is true, and ends the mitigation level setting processing when Σ{Tr−(Ts+ΔT)}≧V2 is not true. When Σ{Tr−(Ts+ΔT)}≧V2 is true, this means that the room temperature Tr frequently exceeds the set temperature Ts by an amount equal to or greater than ΔT (that is, a state of performance deficiency where the indoor unit 30a is thermo-ON but the cell space is not being cooled sufficiently).

In the next step S18, the mitigation control unit 12 commands the control unit 8 of the air conditioner 2 to lower the mitigation level of the indoor unit 30a by one level. When the mitigation level is already set to the normal level Lv0, the control unit 8 of the air conditioner 2 does nothing. When step S18 ends, the mitigation level setting processing also ends.

On the other hand, in step S19, which is executed in the case of the heating operation mode, the state detection unit 11 compares the value of Σ(Tr−Ts) calculated in step S12 with a predetermined value V3 (in the present embodiment, 0° C.).

That is, the state detection unit 11 judges whether or not Σ(Tr−Ts)>V3 is true, proceeds to step S20 when Σ(Tr−Ts)>V3 is true, and proceeds to step S21 when Σ(Tr−Ts)>V3 is not true. When Σ(Tr−Ts)>V3 is true, this means that during the past amount of time K2, the room temperature Tr inside the cell space Sa disproportionately exceeded the set temperature Ts. That is, in step S19, it is judged whether or not the cell space Sa is in the increased energy state.

In step S20, the mitigation control unit 12 commands the control unit 8 of the air conditioner 2 to raise the mitigation level of the indoor unit 30a by one level. When the mitigation level is already at the maximum level Lv5, the control unit 8 of the air conditioner 2 does nothing. When step S20 ends, the mitigation level setting processing also ends.

In step S21, the state detection unit 11 calculates, for the past amount of time K2, a difference value that is the room temperature Tr minus the difference that is the set temperature Ts at the times of detection of that room temperature Tr minus ΔT (see FIGS. 4 and 5) on the basis of the past amount of time K2's worth of room temperature Tr and set temperature Ts data acquired in step S11 and integrates the calculated difference values.

That is, the state detection unit 11 calculates Σ{Tr−(Ts−ΔT)}. Σ means integration corresponding to the number of times of detection K2/K1 (in the present embodiment, 1 hour/5 minutes=12 times) of the room temperature Tr in the past amount of time K2.

In the next step S22, the state detection unit 11 compares the value of Σ{Tr−(Ts−ΔT)} calculated in step S21 with a predetermined value V4 (in the present embodiment, 0° C.).

That is, the state detection unit 11 judges whether or not Σ{Tr−(Ts−ΔT)}≦V4 is true, proceeds to step S23 when Σ{Tr−(Ts−ΔT)}≦V4 is true, and ends the mitigation level setting processing when Σ{Tr−(Ts−ΔT)}≦V4 is not true. When Σ{Tr−(Ts−ΔT)}≦V4 is true, this means that the room temperature Tr is frequently below the set temperature Ts by an amount equal to or greater than ΔT (that is, a state of performance deficiency where the indoor unit 30a is thermo-ON but the cell space Sa is not being heated sufficiently).

In the next step S23, the mitigation control unit 12 commands the control unit 8 of the air conditioner 2 to lower the mitigation level of the indoor unit 30a by one level. When the mitigation level is already set to the normal level Lv0, the control unit 8 of the air conditioner 2 does nothing. When step S23 ends, the mitigation level setting processing also ends.

### <Flow of Mitigation Level Reset Processing>

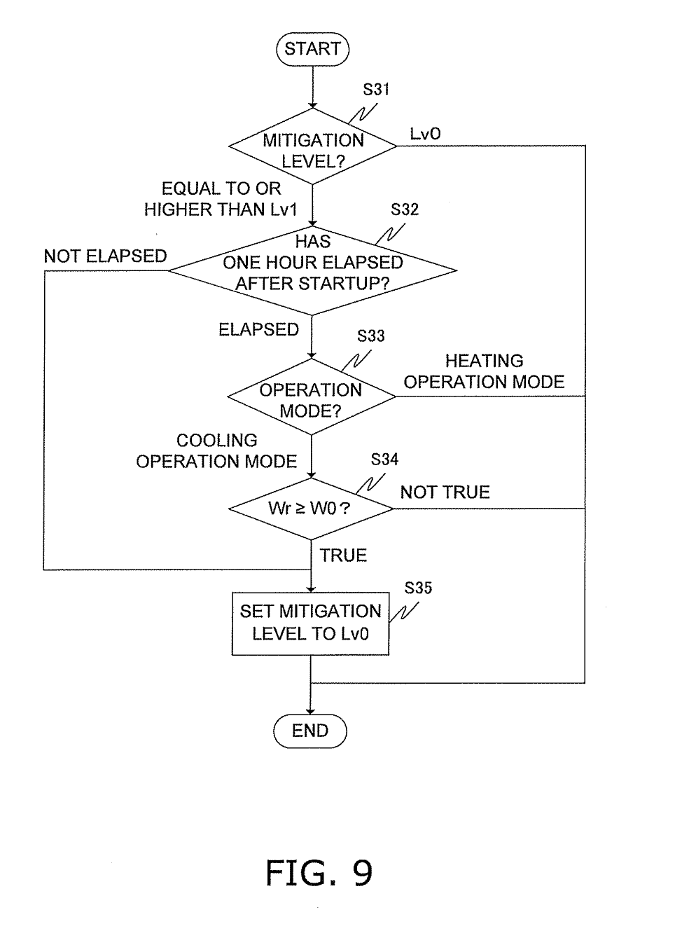

A flow of mitigation level reset processing will be described with reference to FIG. 9. This processing is executed in regard to each of the indoor units 30a, 30b, . . . , 30y at a predetermined time interval (in the present embodiment, every 5 minutes). The mitigation level reset processing is processing that resets as needed the mitigation levels (returns the mitigation levels to Lv0) that have been set by the mitigation level setting processing that is started periodically. In the description below, a case where the processing is executed in regard to the indoor unit 30a will be exemplified.

In step S31, the mitigation prohibition unit 13 determines the current mitigation level. If the current mitigation level is Lv0, the mitigation level reset processing ends, and if the current mitigation level is equal to or higher than Lv1, the mitigation prohibition unit 13 proceeds to step S32.

In S32, the mitigation prohibition unit 13 judges whether or not a predetermined amount of time K5 (in the present embodiment, 1 hour) has elapsed after the indoor unit 30a has started up. When it is judged that the predetermined amount of time K5 has elapsed, the mitigation prohibition unit 13 proceeds to step S33, and when it is judged that the predetermined amount of time K5 has not elapsed, the mitigation prohibition unit 13 proceeds to later-described step S35 that resets the mitigation level. This is because, when the mitigation level ends up being set to Lv1 or higher within the predetermined amount of time (in the present embodiment, 1 hour) after startup, the room temperature Tr inside the cell space Sa is delayed in reaching the set temperature Ts and can impart a feeling of discomfort to the user, so it is necessary to reset the mitigation level.

In the next step S33, the mitigation prohibition unit 13 checks the current operation mode of the indoor unit 30a, proceeds to step S34 when the current operation mode is the cooling operation mode, and ends the mitigation level reset processing without executing step S34 when the current operation mode is the heating operation mode.

In step S34, the mitigation prohibition unit 13 acquires outdoor humidity Wr data from the humidity sensor 67 attached to the outdoor unit 40. Then, the mitigation prohibition unit 13 compares the outdoor humidity Wr with a predetermined value W0 (in the present embodiment, 90%).

That is, the mitigation prohibition unit 13 determines whether or not Wr≧W0 is true; when Wr≧W0 is not true, the mitigation prohibition unit 13 ends the mitigation level reset processing without executing step S35 that resets the mitigation level, and when Wr≧W0 is true, the mitigation prohibition unit 13 proceeds to step S35 that resets the mitigation level. This is because, when cooling operation is being mitigated while the outdoor humidity Wr is high, the inside of the cell space Sa is not sufficiently dehumidified and can impart a feeling of discomfort to the user, so it is necessary to reset the mitigation level.

In step S35, the mitigation prohibition unit 13 commands the control unit 8 of the air conditioner 2 to set the mitigation level of the indoor unit 30a to Lv0. When step S35 ends, the mitigation level reset processing also ends.

### <Characteristics>

When the above-described controller 1 judges that the cell spaces Sa, Sb, . . . , Sy are being excessively air-conditioned, the controller 1 commands the air conditioner 2 to narrow the degree of opening of the expansion valves 32 to decrease the amount of refrigerant flowing through the indoor units 30a, 30b, . . . , 30y. Thus, energy-saving air conditioning operation becomes realized. The state where the cell spaces are excessively air-conditioned (the increased energy state) is a state where the cell spaces Sa, Sb, . . . , Sy are cooled below the set temperature Ts and are substantially stable during cooling operation or a state where the cell spaces Sa, Sb, . . . , Sy are heated above the set temperature Ts and are substantially stable during heating operation.

### <Modifications>

(1)

The state detection unit 11, the mitigation control unit 12, the mitigation prohibition unit 13 and the data collection unit 14 of the controller 1 may also be incorporated into the control unit 8 of the air conditioner 2. That is, the mitigation level setting processing and reset processing by the controller 1 may also be executed by the control unit 8.

(2)

In the above-described embodiment, detection of the increased energy state by the state detection unit 11 may also be performed in the following manner.

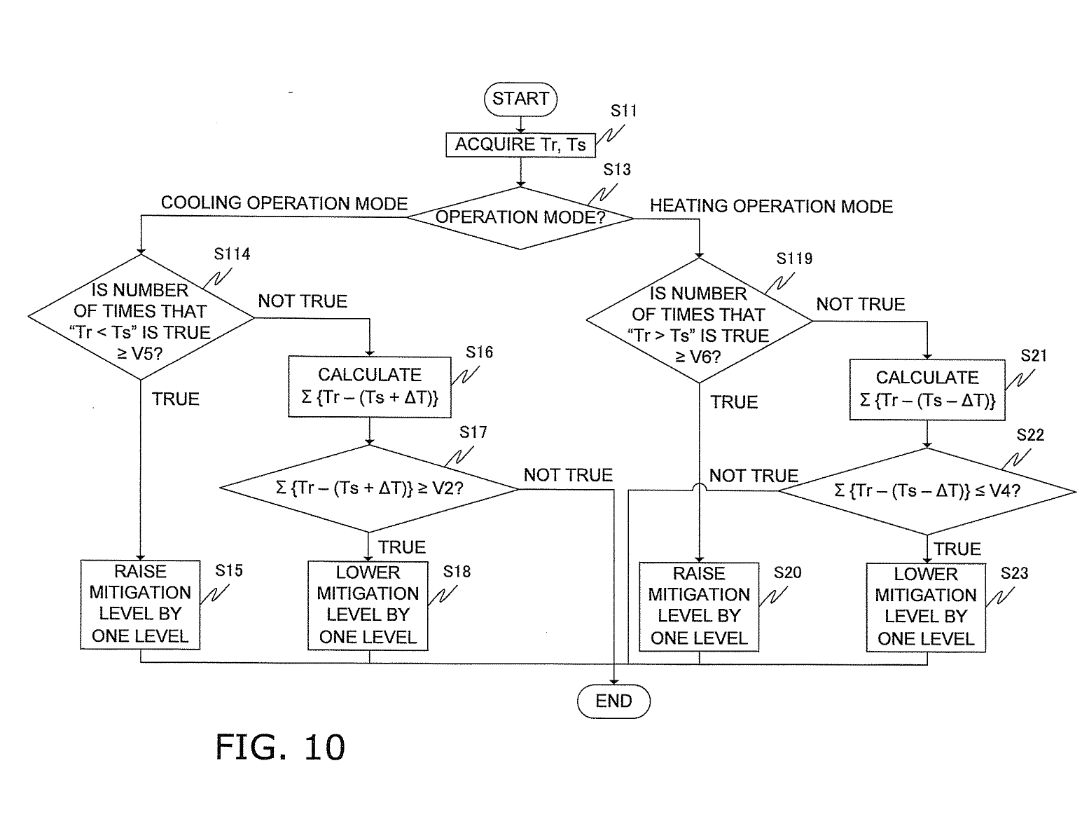

That is, as shown in FIG. 10, step S12 may be omitted, step S114 may be inserted in place of step S14, and step S119 may be inserted in place of step S19.

In step S114, which is executed in the case of the cooling operation mode, the state detection unit 11 performs a comparison between the room temperature Tr detected within the past amount of time K2 and the set temperature Ts at the times of detection of that room temperature Tr on the basis of the past amount of time K2's worth of room temperature Tr and set temperature Ts data acquired in step S11.

That is, the state detection unit 11 judges, K2/K1 times (in the present embodiment, 1 hour/5 minutes=12 times), whether or not Tr<Ts is true; when Tr<Ts is true a number of times equal to or greater than V5 times (in the present embodiment, 10 times), the state detection unit 11 proceeds to step S15, and when Tr<Ts is not true a number of times equal to or greater than V5 times, the state detection unit 11 proceeds to step S16.

Further, in step S119, which is executed in the case of the heating operation mode, the state detection unit 11 performs a comparison between the room temperature Tr detected within the past amount of time K2 and the set temperature Ts at the times of detection of that room temperature Tr on the basis of the past amount of time K2's worth of room temperature Tr and set temperature Ts data acquired in step S11.

That is, the state detection unit 11 judges, K2/K1 times (in the present embodiment, 1 hour/5 minutes=12 times), whether or not Tr>Ts is true; when Tr>Ts is true a number of times equal to or greater than V6 times (in the present embodiment, 10 times), the state detection unit 11 proceeds to step S20, and when Tr>Ts is not true a number of times equal to or greater than V6 times, the state detection unit 11 proceeds to step S21.

(3)

In the above-described embodiment, detection of the increased energy state by the state detection unit 11 may also be performed in the following manner.

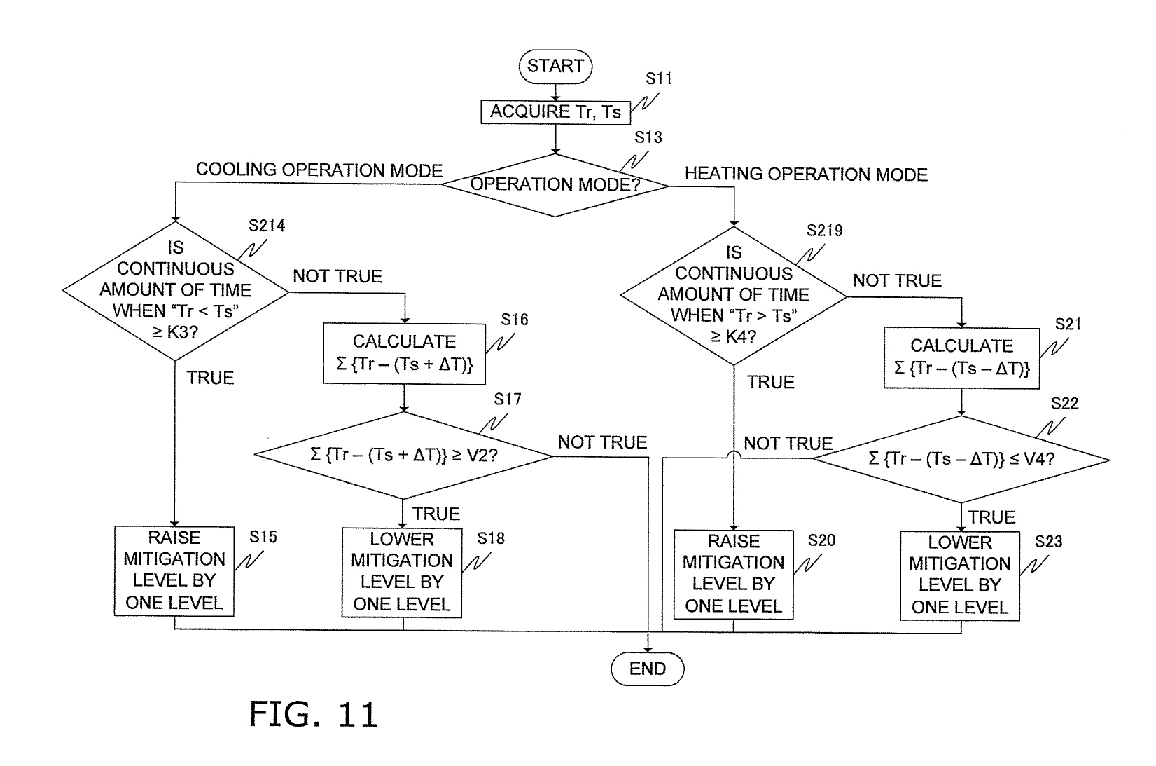

That is, as shown in FIG. 11, step S12 may be omitted, step S214 may be inserted in place of step S14, and step S219 may be inserted in place of step S19.

In step S214, which is executed in the case of the cooling operation mode, the state detection unit 11 judges how long the room temperature Tr continues to be lower than the set temperature Ts at the times of detection of that room temperature Tr on the basis of the past amount of time K2's worth of room temperature Tr and set temperature Ts data acquired in step S11.

That is, when Tr<Ts continues to be true for an amount of time equal to or greater than a predetermined amount of time K3 (in the present embodiment, 30 minutes), the state detection unit 11 proceeds to step S15, and when Tr<Ts does not continue to be true for an amount of time equal to or greater than the predetermined amount of time K3, the state detection unit 11 proceeds to step S16.

Further, in step 219, which is executed in the case of the heating operation mode, the state detection unit 11 judges how long the room temperature Tr continues to be higher than the set temperature Ts at the times of detection of that room temperature Tr on the basis of the past amount of time K2's worth of room temperature Tr and set temperature Ts data acquired in step S11.

That is, when Tr>Ts continues to be true for an amount of time equal to or greater than a predetermined amount of time K4 (in the present embodiment, 30 minutes), the state detection unit 11 proceeds to step S20, and when Tr>Ts does not continue to be true for an amount of time equal to or greater than the predetermined amount of time K4, the state detection unit 11 proceeds to step S21.

(4)

In the above-described embodiment, the mitigation prohibition unit 13 resets the mitigation level when a predetermined condition is satisfied. However, the mitigation prohibition unit 13 may also be configured such that, rather than resetting the mitigation level after setting the mitigation level to Lv1 or higher, it judges whether or not the predetermined condition is satisfied immediately before setting the mitigation level to Lv1 or higher and does not at all set the mitigation level to Lv1 or higher under the predetermined condition.

(5)

In the above-described embodiment, the controller 1 is configured to mitigate air conditioning operation by reducing the degree of opening of the expansion valve 32 as the mitigation level becomes higher. However, the controller 1 may also be configured to mitigate air conditioning operation by changing other control parameters.

For example, the controller 1 may also perform control that raises the degree of superheating of the refrigerant in an outlet of the heat exchanger 31 or 43 as the mitigation level becomes higher.

Further, the controller 1 may also perform control that raises the degree of supercooling of the refrigerant in an outlet of the heat exchanger 31 or 43 as the mitigation level becomes higher.

Further, the controller 1 may also perform control that lowers the frequency of the compressor 41 as the mitigation level becomes higher.

Further, the controller 1 may also perform control that raises the evaporation temperature of the refrigerant as the mitigation level becomes higher.

Further, the controller 1 may also perform control that lowers the condensation temperature of the refrigerant as the mitigation level becomes higher. Further, if it is during cooling operation, the controller 1 may also perform control that raises the set temperature Ts as the mitigation level becomes higher.

Further, if it is during heating operation, the controller 1 may also perform control that lowers the set temperature Ts as the mitigation level becomes higher.

(6)

In the mitigation level reset processing of the above-described embodiment, the mitigation level is reset when the outdoor humidity Wr is higher than the predetermined value W0 (in the present embodiment, 90%). However, the mitigation prohibition unit 13 may also be configured to acquire meteorological data (rainy weather, rainy season, etc.) by manual input of a user or automatically from a predetermined data server via a communication line, detect the humid state of the outdoor air, and reset the mitigation level.

(7)

In the above-described embodiment, the mitigation level is reconsidered at a predetermined time interval (every 1 hour), and when the mitigation level is to be raised, the mitigation level is raised by only one level at a time. However, when the degree of increased energy is large, the mitigation level may also be raised by two or more levels at a time depending on that degree.

(8)

In the mitigation level reset processing of the above-described embodiment, a method of setting the mitigation level to Lv0 is employed as a method of lowering the mitigation level. However, instead of this method, a method of “storing the mitigation level before resetting and returning the mitigation level to the mitigation level before resetting as soon as the condition of mitigation prohibition is removed” may also be employed.

(9)

The mitigation level reset processing of the above-described embodiment is executed using all of the indoor units 30a, 30b, . . . , 30y as targets. However, the targets on which the mitigation level reset processing is to be performed may also be limited to some of the indoor units 30a, 30b, . . . , 30y located inside the same room (e.g., limiting the number of indoor units, or limiting the mitigation level reset processing to only the indoor units 30a, 30b, . . . , 30y in particular positions).

(10)

The above-described modifications may also be arbitrarily combined.

### INDUSTRIAL APPLICABILITY

The present invention has the effect that it can avoid a situation where an air conditioning target space is excessively air-conditioned and can realize energy-saving air conditioning operation, and the present invention is useful as an air conditioning control device, an air conditioning apparatus, and an air conditioning control method.

1. An air conditioning control device for controlling an air conditioner having a utilization unit and a heat source unit, the air conditioning control device comprising:
a state detection unit configured to detect an increased energy state where a space temperature of an air conditioning target space of the utilization unit is
frequently below a set temperature of the utilization unit during cooling operation or
frequently exceeds the set temperature of the utilization unit during heating operation; and
a mitigation control unit configured to control the air conditioner so as to mitigate the increased energy state when the state detection unit detects the increased energy state.

2. The air conditioning control device according to claim 1, wherein
the mitigation control unit is further configured to control the air conditioner such that an amount of refrigerant flowing through the utilization unit decreases when the state detection unit detects the increased energy state.

3. The air conditioning control device according to claim 1, wherein
the state detection unit is further configured
to detect a difference value, the difference value being the space temperature minus the set temperature a predetermined number of times, and
to detect the increased energy state
when an integrated value of the difference values is smaller than a first value during cooling operation or
when the integrated value of the difference values is larger than a second value during heating operation.

4. The air conditioning control device according to claim 1, wherein
the state detection unit is further configured
to determine a magnitude relation between the space temperature and the set temperature a first number of times, and
to detect the increased energy state
when the space temperature is smaller a number of times equal to or greater than a second number of times during cooling operation or
when the space temperature is larger a number of times equal to or greater than a third number of times during heating operation.

5. The air conditioning control device according to claim 1, wherein
the state detection unit is further configured to detect the increased energy state
when the space temperature continues to be below the set temperature an amount of time longer than a first amount of time during cooling operation or
when the space temperature continues to exceed the set temperature an amount of time longer than a second amount of time during heating operation.

6. The air conditioning control device according to claim 1, wherein
the mitigation control unit is further configured to execute at least one control selected from the group consisting of
expansion mechanism control that reduces the degree of opening of an expansion mechanism included in the utilization unit,
degree-of-superheating control that raises the degree of superheating, degree-of-supercooling control that raises the degree of supercooling,
compressor control that lowers the frequency of a compressor,
evaporation temperature control that raises the evaporation temperature of the refrigerant,
condensation temperature control that lowers the condensation temperature of the refrigerant,
cooling set temperature control that raises the set temperature during cooling operation, and
heating set temperature control that lowers the set temperature during heating operation.

7. The air conditioning control device according to claim 1, further comprising
a mitigation prohibition unit configured to prohibit control by the mitigation control unit under at least one situation selected from the group consisting of
a situation where outdoor humidity is higher than a predetermined humidity value,
a situation that is rainy weather, and
a situation that is within a predetermined period after startup of the air conditioner.

8. An air conditioning apparatus comprising:
a heat source unit;
a utilization unit configured and arranged to be connected via a refrigerant pipe to the heat source unit; and
a control unit configured to control operation of the heat source unit and the utilization unit, the control unit having
a state detection unit configured to detect an increased energy state where a space temperature of an air conditioning target space of the utilization unit is
frequently below a set temperature of the utilization unit during cooling operation or
frequently exceeds the set temperature of the utilization unit during heating operation and
a mitigation control unit configured to control the heat source unit and the utilization unit so as to mitigate the increased energy state when the state detection unit detects the increased energy state.

9. An air conditioning control method for controlling an air conditioner having a utilization unit and a heat source unit, the method comprising:
detecting an increased energy state where a space temperature of an air conditioning target space of the utilization unit is
frequently below a set temperature of the utilization unit during cooling operation or
frequently exceeds the set temperature of the utilization unit during heating operation; and
controlling the air conditioner so as to mitigate the increased energy state when the increased energy state is detected.

10. The air conditioning control device according to claim 2, wherein the state detection unit is further configured
to detect a difference value, the difference value being the space temperature minus the set temperature a predetermined number of times, and
to detect the increased energy state
when an integrated value of the difference values is smaller than a first value during cooling operation or
when the integrated value of the difference values is larger than a second value during heating operation.

11. The air conditioning control device according to claim 2, wherein the state detection unit is further configured
to determine a magnitude relation between the space temperature and the set temperature a first number of times, and
to detect the increased energy state
when the space temperature is smaller a number of times equal to or greater than a second number of times during cooling operation or
when the space temperature is larger a number of times equal to or greater than a third number of times during heating operation.

12. The air conditioning control device according to claim 2, wherein the state detection unit is further configured to detect the increased energy state
when the space temperature continues to be below the set temperature an amount of time longer than a first amount of time during cooling operation or
when the space temperature continues to exceed the set temperature an amount of time longer than a second amount of time during heating operation.

13. The air conditioning control device according to claim 2, wherein
the mitigation control unit is further configured to execute at least one control selected from the group consisting of
expansion mechanism control that reduces the degree of opening of an expansion mechanism included in the utilization unit,
degree-of-superheating control that raises the degree of superheating, degree-of-supercooling control that raises the degree of supercooling,
compressor control that lowers the frequency of a compressor,
evaporation temperature control that raises the evaporation temperature of the refrigerant,
condensation temperature control that lowers the condensation temperature of the refrigerant,
cooling set temperature control that raises the set temperature during cooling operation, and
heating set temperature control that lowers the set temperature during heating operation.

14. The air conditioning control device according to claim 2, further comprising
a mitigation prohibition unit configured to prohibit control by the mitigation control unit under at least one situation selected from the group consisting of
a situation where outdoor humidity is higher than a predetermined humidity value,
a situation that is rainy weather, and
a situation that is within a predetermined period after startup of the air conditioner.

15. The air conditioning control device according to claim 3, wherein
the mitigation control unit is further configured to execute at least one control selected from the group consisting of
expansion mechanism control that reduces the degree of opening of an expansion mechanism included in the utilization unit,
degree-of-superheating control that raises the degree of superheating, degree-of-supercooling control that raises the degree of supercooling,
compressor control that lowers the frequency of a compressor,
evaporation temperature control that raises the evaporation temperature of the refrigerant,
condensation temperature control that lowers the condensation temperature of the refrigerant,
cooling set temperature control that raises the set temperature during cooling operation, and
heating set temperature control that lowers the set temperature during heating operation.

16. The air conditioning control device according to claim 3, further comprising
a mitigation prohibition unit configured to prohibit control by the mitigation control unit under at least one situation selected from the group consisting of
a situation where outdoor humidity is higher than a predetermined humidity value,
a situation that is rainy weather, and
a situation that is within a predetermined period after startup of the air conditioner.

17. The air conditioning control device according to claim 4, wherein
the mitigation control unit is further configured to execute at least one control selected from the group consisting of
expansion mechanism control that reduces the degree of opening of an expansion mechanism included in the utilization unit,
degree-of-superheating control that raises the degree of superheating, degree-of-supercooling control that raises the degree of supercooling,
compressor control that lowers the frequency of a compressor,
evaporation temperature control that raises the evaporation temperature of the refrigerant,
condensation temperature control that lowers the condensation temperature of the refrigerant,
cooling set temperature control that raises the set temperature during cooling operation, and
heating set temperature control that lowers the set temperature during heating operation.

18. The air conditioning control device according to claim 4, further comprising
a mitigation prohibition unit configured to prohibit control by the mitigation control unit under at least one situation selected from the group consisting of
a situation where outdoor humidity is higher than a predetermined humidity value,
a situation that is rainy weather, and
a situation that is within a predetermined period after startup of the air conditioner.

19. The air conditioning control device according to claim 5, wherein
the mitigation control unit is further configured to execute at least one control selected from the group consisting of
expansion mechanism control that reduces the degree of opening of an expansion mechanism included in the utilization unit,
degree-of-superheating control that raises the degree of superheating, degree-of-supercooling control that raises the degree of supercooling,
compressor control that lowers the frequency of a compressor,
evaporation temperature control that raises the evaporation temperature of the refrigerant,
condensation temperature control that lowers the condensation temperature of the refrigerant,
cooling set temperature control that raises the set temperature during cooling operation, and
heating set temperature control that lowers the set temperature during heating operation.

20. The air conditioning control device according to claim 5, further comprising
a mitigation prohibition unit configured to prohibit control by the mitigation control unit under at least one situation selected from the group consisting of
a situation where outdoor humidity is higher than a predetermined humidity value,
a situation that is rainy weather, and
a situation that is within a predetermined period after startup of the air conditioner.
